(19) United States
(12) Patent Application Publication
(10) Pub. No.: US 2021/0049647 A1
(43) Pub. Date: Feb. 18, 2021

(54) MEANS FOR BROADCASTING A PERSONALIZED CONTENT IN A COMMUNICATION NETWORK

(71) Applicant: QWANT ENTERPRISE, SAS, Paris (FR)

(72) Inventors: Eric MATHIEU, Paris (FR); Cyril MARCH, Paris (FR); Bruno PRELY, Paris (FR)

(21) Appl. No.: 16/323,487

(22) PCT Filed: Aug. 4, 2017
(86) PCT No.: PCT/FR2017/052197

§ 371 Date: Feb. 5, 2019

(30) Foreign Application Priority Data
Aug. 5, 2016 (FR) 16/57604

(51) Int. Cl. G06Q 30/02; G06F 16/955; G06F 16/954; G06F 16/957; G06F 16/958

(52) U.S. Cl. CPC G06Q 30/0271; G06F 16/9566; G06F 16/958; G06F 16/9574; G06F 16/954

(57) ABSTRACT

The present invention is adapted to be implemented for a search engine allowing iterations during the search for content. The invention determines and broadcasts a personalized content, by: •collecting information relating to at least one interaction of a user •determining at least one centre of interest of the user, •determining at least one measurement of the commitment of the user, •determining a context characterization related to the current session and a characterization of a degree of interest of the user •broadcasting, to the navigation module, a content personalized as a function of the characterization of the centre of interest and of the degree of commitment determined.

The present invention relates to the field of broadcasting automatically personalized information in an information system. The invention concerns more specifically means for implementing, in a communication network, spaces for broadcasting personalized information to a user, as a function of interests specific to said user. The spaces for broadcasting information can be, in particular, advertising spaces, or spaces reserved for recommended content, intended to be displayed either on a website page consulted by the user, during a session opened by means of a web browser, or within an application embedded in a mobile device (a mobile telephone/smartphone, or tablet) during his consultation.

Many websites, and applications on mobile devices, propose personalization of a portion of the content—in particular, but not exclusively, advertising messages—broadcast to a user, as a function of the user's activities on the numerous websites consulted previously. For example, online advertisers are especially interested in the possibility of identifying, in advance, the users interested in content presented, in particular the users likely to or intending to buy a product.

A first approach, suitable for websites comprising a search engine, can consist of displaying a personalized content, as a function for example of keywords entered by the user and used to clarify a search request. While this first approach can prove effective, the content personalization remains insufficient with regard to the precise understanding, in real time, of the user's center of interest and commitment (ie his receptiveness to a specific content), and his particular intentions. Cookies, managed by the web browser or by the connection to an application on a mobile device with the user's name and his password (for example when it was downloaded), are generally used for this purpose. In the case of broadcasting advertising, the cookies thus enable the user to be identified individually as a consumer and to propose an advertising message, on the current site or application consulted, that is related to his interests and past searches recorded previously. This method of content personalization, based on these cookies, is usually referred to as “Behavioral retargeting”. The targeting of advertising is therefore based on the individual recognition of the user associated with his history of his previous consultations, and therefore makes it possible to target the user, based on his past centers of interest, hence the term “retargeting”, the user being already known to the advertiser.

Consequently, most of the personalization methods used by the existing profiling systems require the user to be uniquely identified, and the personalization of the content is based on capturing a history of data specific to this user. The captured data are collected from a single site—for example, an e-commerce site—or from several sites, grouped within a network purchasing advertising spaces, or content recommendations. In the latter configuration, a single service for identifying and profiling the user is typically used to store the user's profile, comprising for example information relating to his interests (previous sites and pages consulted, previous searches made with keywords) and his behavior during previous visits to one or more websites.

However, uniquely identifying a user poses many problems. While it is not always necessary to know the user's identity or his marketing profile (for example, his name, gender, socio-demographic segment, etc), in certain cases this practice can encounter rules concerning the right to privacy, prescribed by various laws according to the jurisdiction(s) in question. In addition, the browsers and supplementary technical means make it possible to restrict, or even forbid, the use of cookies, which can make this method ineffective, in the absence of a pertinent targeting process.

That is why the need still exists for means for broadcasting a personalized content in a communication network that can ensure the anonymity of the user and can operate without using cookies.

The invention envisages providing means for implementing, in a communication network, spaces for broadcasting personalized information to a user, as a function of the user's current center of interest, and therefore specific to his current consultation, and not to his past browsing, even on other sites. The spaces broadcasting information can be, in particular, advertising spaces, intended to be displayed either on a website page consulted by the user, during a session opened by means of a web browser, or within an application on a mobile device.

The invention also envisages proposing technical means suitable for implementing an infrastructure selling advertising spaces, based on the iterative refining of the user's center of interest using data extracted from the content of the website consulted during the user's current session, and without considering this user's past browsing history on this same website or other websites. The object of the invention is also to take into account the user's engagement with the content presented, during a session, taking into account the user's interactions, and the way in which the content is consumed.

Another object of the invention is to enable a user's behavior to be characterized, anonymously, with respect to a subject, in terms of the level of engagement, ie receptiveness, of the subject. Another object of the invention is to enable the anonymous characterization a user's behavior with respect to a subject, in terms of the user's intention, so as to make it possible to determine a probability that the user will interact with an advertisement and, where appropriate, to redirect the user to another site where a purchase can be made.

The invention also envisages proposing technical means for an infrastructure selling advertising spaces using iterative refining, these means being able to characterize and improve the precision of the center of interest through iterative refining, as a function of the entire path in the content consulted, ie browsing in the pages, actions on the content, the various searches by menus and filters or keywords, the positive and/or negative selection of content, and more generally the successive actions and requests made as part of the current search, including their sequences and variations within the iterative cycle of the search. The invention is therefore not limited to expressing the last search request or action in the content.

One or more of these objects are met by the broadcasting method, computer program, media, module and system that are the subjects of independent claims. The dependent claims also provide solutions to these objects and/or other advantages.

In the present description, “center of interest” refers to that which characterizes and summarizes the “context”, ie the content itself of the pages viewed, the metadata of the pages, which may not be displayed, and also the conduct of the session, such as the sequence of interactions, the navigation path, any content selection, and more generally the content itself and all the actions making it possible to obtain the content viewed during the session. Among others, the center of interest includes content selection actions such as:
browsing actions in the content and the topics of the pages viewed;
actions available through a menu, by filtering;
opinions expressed by a user about specific content (eg adding a comment “I like”, etc);
content search actions, which can use keywords, or any other actions on the content—I like/don't like, etc—and which can also contribute to the content search by a text-based multimedia search engine.

In the present description, “commitment of the user” refers to the user's receptiveness to the content, which can be measured by the way in which the content is consulted and the user's interactivity with the content. The commitment is basically behavioral, therefore here are some examples to illustrate this:
the fact of reading an article through to the end, which can be identified by scrolling, using the scroll bar of the corresponding page, through to the end of the article;
the fact of letting a video play without closing it or stopping playback before it ends;
the fact of interacting with a website or an application allowing a preference to be expressed by “Like/Don't like”, indicates a greater or lesser interest in the content presented, and also a strong commitment through interactivity;
etc.

In the present description, “commitment variable” regarding a certain number of aspects refers to information concerning the user's commitment, such as, for example, a percentage of the portion of an article displayed, a time an article is displayed, a percentage of a video played, a number of clicks during the session, etc, and any combination of variables that can be calculated (for example, on a scale of 0 to 10), and which can also allow more global parameters to be determined, such as:
a degree of interest: reading/attention to the content (scrolling through text, looking at images, viewing videos);
a degree of interactivity with the content: scrolling the content partially or completely, slowly or quickly, searches, browsing, etc.

In the present description, “degree of intent” refers to a probability of clicking on the links to other content or advertisements presented.

More specifically, according to a first aspect, the invention relates to a method for broadcasting personalized content, in a communication network, to a navigation module, during a session established between the navigation module and a content server module, referred to as the current session. The content server module can be a website, or a data source suitable for use by the navigation module. The navigation module can be, in particular, a web browser or an application suitable to be executed by a terminal and configured to use data supplied by the content server module. The method comprises the following steps:
a first step of collecting information relating to at least one interaction of a user, by means of a navigation module, with at least one content page prepared at least partially from data transmitted by the content server module;
a second step of determining a context variable relating to at least one center of interest of the user, as a function of information relating to said at least one interaction of a user collected during the first step;
a third step of determining at least one commitment variable of the user with said at least one content page, as a function of information relating to said at least one interaction of a user collected during the first step;
a fourth step of characterizing the current session as a function of a historical data set of anonymized previous sessions:
   of the context as a function of said at least one context variable relating to at least one center of interest of the user; and
   of said at least one measurement of the user's commitment or at least one measurement of the user's degree of interest, as a function of said at least one commitment variable determined during the third step;
a fifth step of broadcasting, to the navigation module, a content personalized as a function of the characterization of the context and of the characterization of said at least one measurement of the degree of commitment or said at least one measurement of the degree of interest, determined during the fourth step.

During the fifth step, the content personalized for the user can be determined and/or selected by a content provider module, as a function of the characterization of the context and of the characterization of said at least one measurement of the center of interest, and of said at least one measurement of the degree of commitment, determined during the fourth step. The content provider module can belong to the system according to the fifth aspect or be managed by a third party.

During the first step, the collecting of information relating to at least one interaction of a user can be reduced to collecting an item of basic information, for example collecting a unique keyword, during a first content search. In particular, said at least one content page can be a web page transmitted to the navigation module during the session.

The invention makes it possible to take into account information going beyond a first characterization of the center of interest obtained after the user enters one or more initial keywords or a semantic summary of a page. The invention makes it possible, in particular, to take into account several successive content pages or several search iterations based on keywords, and all preferences, positive or negative, expressed by the user about content presented successively. The invention therefore makes it possible to take into account the path of the search made by the user, in particular the information entered or selected, and also the information consulted during a succession of search requests having generated multiple lists of results. Consequently, it is therefore possible to optimally characterize the user's center of interest, which is not reduced until the last request, or interaction of the user, is taken into account, and as a result provide a relevant personalized content related to the user's entire current session, including through to his last request or interaction.

The steps of the method according to the invention can also be repeated, for example periodically or when a specific event is detected, such as a new interaction by the user with the navigation module.

The navigation module can be implemented by means of a personal computer, or an application on a mobile device. In particular, the first step can be executed periodically or after detecting a new interaction by the user within a content page transmitted by the content server module. In this way, the personalized content proposed to the navigation module can be determined and improved at each new interaction by the user.

The method for broadcasting a personalized content according to the first aspect is especially suitable for implementation by an advertising space sales system using refinement. The method according to the first aspect thus makes it possible to refine, by iteration, firstly the user's current interest in terms of the present center of interest, and secondly the measurement of his commitment with regard to the content presented, in relation to his present center of interest, and/or the prediction of the degree of commitment, such as the potential intention to purchase (in the case of commercial services or products). By collecting, from the website consulted alone or from the content server supplying the application, the content of pages viewed, the keywords and the interaction data or any other means for searching for and accessing new information, and solely for the user's current consultation and/or search session, the method enables the user's own browser history not to be used, and does not require, in particular, the use of cookies for identifying the user and accessing his history. In effect, the method according to the first aspect makes it possible to analyze the user's current activity, ie his activity during the current session, and to deduce from this the signature of the current session, by comparing it to multiple previously profiled and anonymized sessions, in relation to the activity of previous users who had accessed the same types of information on the same website and had similar behaviors and contexts.

The user's activity can be characterized and refined, iteratively, by information about the observed context—which can be keywords in the case of a search engine used to obtain the information viewed—, by the actual center of interest of the user obtained by deduction from the user's current browsing on the site currently being browsed and the user's level of interest in the subjects of the pages consulted. The user's level of interest in a subject is determined in particular by the way in which he interacts with the site's information, by the way in which he searches for information (by links, by keywords, the chaining of the interactions, etc) and the different formats of content viewed (text pages, images and videos, and their combinations). This level of interest can be compared to similar experiences for other users and can be characterized by the degree of interest in the content or the degree of intent in terms of a potential purchase, when it concerns marketable products or services.

Said at least one interaction of the user with said at least one content page, for example a web page transmitted by the content server module, can relate to, but not be limited to, one or a combination of interactions from among the following list: consulting a content page/web page, consulting a sub-section of a content page/web page via a link or a menu, entering a keyword, expressing an interest or non-interest in a multimedia document, action and/or data entry by the user to perform a content search, browsing action and/or data entry by the user to access new information within the content server or website.

During the second step, said at least one context variable can be determined, as a function of the content of said at least one content page or web page transmitted to the navigation module during the session and/or information, not visible to the user, attached to said content, such as metadata.

During the second step, said at least one context variable can be determined, firstly, where applicable, as a function of a selection and/or a combination, on input, of criteria, and/or actions, and/or objects used by the user to formulate, by means of the navigation module, a personalized content search request, intended for a search module associated to the content server module. In this context, the criteria considered can be based on the terms used by the user, either directly or indirectly, for example in the case of metadata associated to documents selected.

During the second step, said at least one context variable can be determined, as a function of a selection and/or a combination, on input, of at least one item of textual information and/or at least one multimedia object, to formulate the personalized content request, intended for the search module associated to the content server module. The request can come, in particular, from a search engine. Said at least one multimedia object can be, in particular, a multimedia object with no limitation on the object's computer format, for example a video, an image, an audio file, a PDF file, an e-commerce product sheet, etc. Said at least one multimedia object can be directly or indirectly selected by the user. The request can be constructed by successive iterations so as to refine the personalized content during a single session. In particular, the request can be constructed by iteration of the user's selections of multimedia objects and/or text entries, and by successive proposals, combinations and refining of the results by the search engine. For example, the search module associated to the content server module can be implemented by the means described in document WO 2014/191703.

During the second step, said at least one context variable can be determined, as a function of the content of said at least one content page transmitted to the navigation module, or keywords collected during the first step, and as a function of at least one reference ontology relating to a plurality of concepts. The reference ontology's plurality of concepts relates, for example, to topics consulted in the subject area, or which can be relevant as marketing segments for the targeting of advertising.

During the third step, said at least one commitment variable of the user with said at least one content page transmitted by the web content server module can be determined as a function of information relating to said at least one interaction of a user collected during the first step.

The historical data set of previous sessions comprises, for example, anonymous data collected during user sessions established between third-party navigation modules and the content server module. The user sessions can, in particular, be sessions of users having previously accessed the content on the content server module, without necessarily having been identified.

The context can be characterized, in particular, with a view to formulating said at least one center of interest of the user. Also, during the fourth step, the characterization of the context can be determined by:
formulating a signature of the session, as a function of said at least one context variable;
comparing the session's signature with the historical data set of anonymized previous user sessions, to determine historicized previous sessions having a signature closest to the session's signature;
using a classification model, to determine the characteristics of the user's current session, as a function of characteristics associated with the historicized sessions having a signature closest, in terms of classification, to the signature of the current session.

To determine the similarity with regard to a classification model, the closeness of the current session can be calculated according to a function of the distance between sessions using automatic learning techniques.

This classification model can be restricted, for example to reflect a marketing micro-segmentation, using automatic learning or machine learning techniques to correspond to a reference ontology of the subject area for the topic consulted, or to an ontology suitable for an advertising targeting use, to define its marketing segment. Similarly, the iterative path of consultation of the content by the user, and also during a content search by an iterative search engine, makes it possible to implement reinforcement learning techniques enabling automatic learning. The objective of this automatic learning is to learn from the historicized sessions and thus to propose, for any new session, optimally personalized content or targeted advertisements according to predefined commitment criteria such as, but not limited to, a content click rate or an advertisement click rate.

During the fifth step, the personalized content can be:
selected from a content set, as a function of the characterization of the content according to said at least one measurement of the center of interest, and of said at least one measurement of the degree of commitment;
transmitted to the navigation module;
displayed by the navigation module.
   The selection from a content set can be performed by a module of a website, on the content server, or by a module hosted on a third-party server in charge of providing the personalized content, or so-called contextual advertisements.

According to a second aspect, the invention relates to a computer program comprising instructions for executing steps of the method according to the first aspect, when said program is executed by a processor.

Each of these programs can use any programming language, and be in the form of source code, object code, or an intermediate language between source code and object code, for example in a partially compiled form, or in any other desired form. In particular, it is possible to use the C/C++ language, Java™ language, or script languages such as, in particular, JavaScript, python, Perl which allow code to be generated “on demand” and not requiring a significant load to generate or modify them.

According to a third aspect, the invention relates to a computer-readable recording medium on which is stored a computer program comprising instructions for executing steps of the method according to the first aspect. The information carrier can be any entity or device capable of storing the program. For example, the medium can comprise a storage means, such as ROM, for example a CD-ROM or a microelectronic circuit ROM, or a magnetic recording means, for example a floppy disk or a hard disk. In addition, the information carrier can be a transmissible carrier, such as an electrical or optical signal, which can be conveyed by an electrical or optical cable, by radio or other means. The program according to the invention can be, in particular, downloaded from an internet or intranet network. Alternatively, the information carrier can be an integrated circuit in which the program is incorporated, the circuit being designed to execute or be used in executing the method in question.

According to a fourth aspect, the invention relates to a module designed to broadcast a personalized content, in a communication network, to a navigation module, during a session established between the navigation module and a content server module. The module comprises:
a module configured to collect information relating to at least one interaction of a user, by means of a navigation module, with at least one content page prepared at least partially from data transmitted by the content server module;
a module configured to determine a context variable relating to at least one center of interest of the user, as a function of information relating to said at least one interaction of a user;
a module configured to determine at least one commitment variable of the user with said at least one content page, as a function of information relating to said at least one interaction of a user;
a module configured to determine, as a function of a historical data set of anonymized previous sessions:
   a characterization of the context as a function of said at least one context variable relating to at least one center of interest of the user; and
   a characterization of said at least one measurement of the user's commitment or at least one measurement of the user's degree of interest, as a function of said at least one commitment variable;
a module configured to broadcast, to the navigation module, a content personalized as a function of the characterization of the context and of the characterization of said at least one measurement of the degree of commitment or said at least one measurement of the degree of interest.

According to a fifth aspect, the invention relates to a system comprising a navigation module, a content server module and a module according to the fourth aspect.

Other advantages and special features of the present invention will become apparent on reading the following description, with reference to the drawings included in an appendix, wherein:

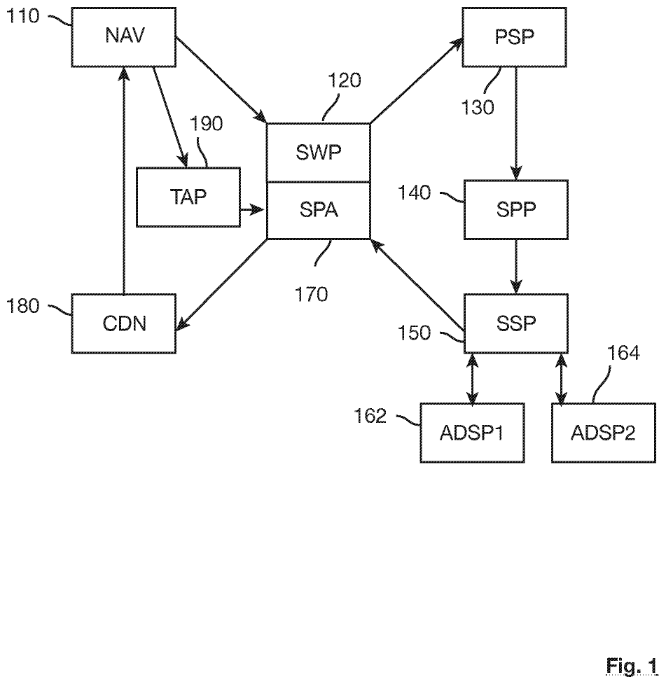

FIG. 1 is a schematic representation of a system for implementing spaces for broadcasting personalized information to a user, according to one embodiment of the invention;

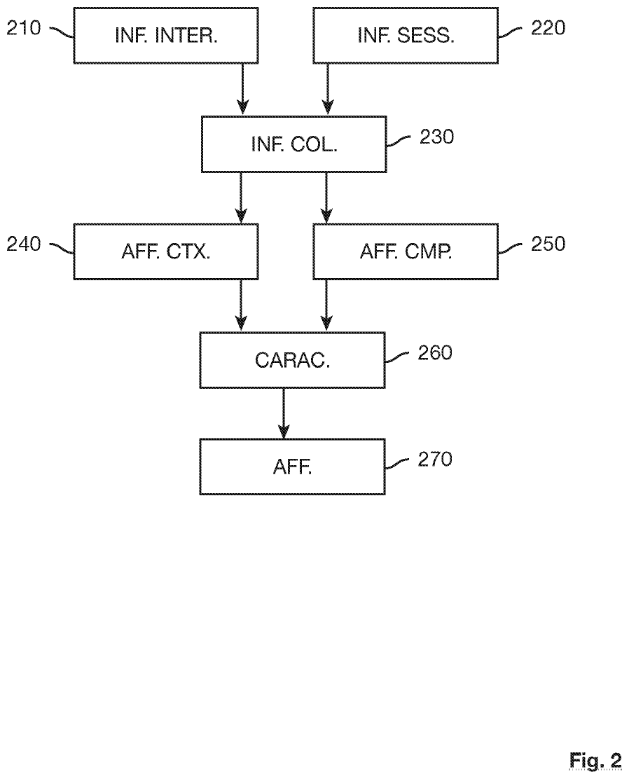

FIG. 2 is a synoptic view of the steps of a method predicting the behavior of the user, according to one embodiment of the invention;

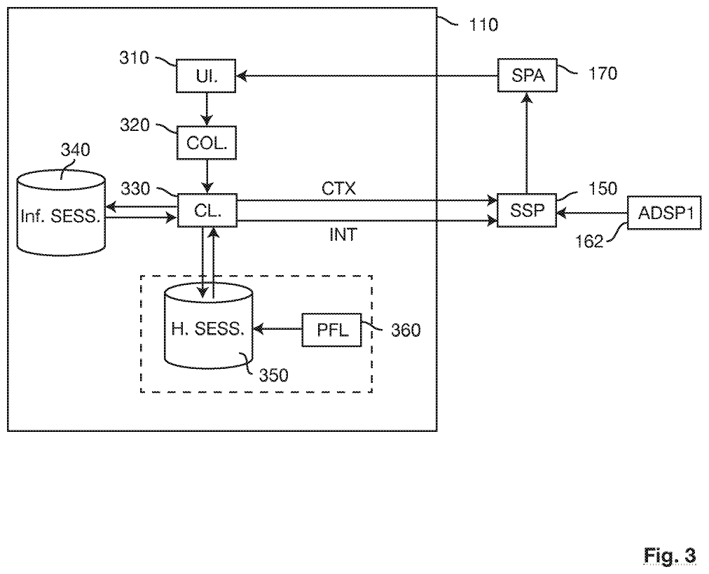

FIG. 3 is a diagram, according to one embodiment, of a navigation module according to the invention.

In this description, the term “session” refers to the period during which a user produces a series of requests by means of his web browser during a visit to a website, of via an application on a mobile device accessing the content server. Therefore, in the context of access to a content server site, a session refers to a delimited period during which a single content server communicates and performs operations for the benefit of a user, connected by means of a computer module executing software to access the content.

To determine the period corresponding to a session, a session management mechanism, able, for example, among other means, to use the session management mechanism associated to the user interface, can be used to determine for each new interaction of the user, where applicable, the start of a new session, the continuation of a session already active, and/or the end of the session, for the same internet browser on the same terminal, for the same application on the mobile device, based on computer criteria, such as the creation of a new session by the browser, or time criteria, following the expiry of the session based on an inactivity time counter. Similarly, the previous criteria can be supplemented or combined with a topic coherence criterion, formulated using the context, and based on the semantic closeness of the content consulted according to a reference ontology, within a session management module making it possible to force the end of the current session, in the case of too great a divergence of subjects, and as a consequence trigger the start of a new session.

FIG. 1 shows a system for implementing spaces for broadcasting personalized information to a user, according to one embodiment of the invention. More specifically, the system can be a system for implementing advertising spaces with characterization and iterative refining of a user's intention in terms of center of interest and commitment. The system is configured to collect and use, for this purpose, information relating to contextual and behavioral data collected during the user's interactions with the pages of a website, or with an application residing on a storage device. This information specific to the user is typically obtained during a single navigation or search activity, that may possibly use a search engine, on the site currently being browsed by the user. The collecting of this information is limited in time, for example during a single session, most often characterized by a limited duration, and a single center of interest by the user.

The system comprises a suitable navigation module 110, which can be in particular a web browser, or an application on a mobile device, such as a Smartphone or a Tablet. The web browser enables a user of the navigation module 110 to access the pages of a website or a

content server, and to consult them and/or interact with said pages or content. The navigation module 110 can be, in particular, embedded in a computer, in a mobile communication terminal, in a connected system, etc.

The system comprises a content server module 120, coupled to the internet and hosted by or on behalf of a content publisher, designed to store, generate and transmit web pages or content to the navigation module 110, on request from the latter.

The web server module 120 is coupled to a session profiling module 130. The session profiling module 130 uses one or more artificial intelligence, clustering learning, reinforcement learning techniques, in order to determine the signature of the current session, and to recalculate it on each iteration, taking into account the history of the entire session. The session signature recalculated during the last iteration is compared and classified with regard to the previous anonymized user sessions. Profiling by classification makes it possible to formulate in return at least one center of interest, and at least one measurement of the degree of commitment. The session profiling module 130 then transmits to the personalized content publisher server module 140 the center of interest that can be the tag, ie the name of the cluster of sessions in which the session has been assigned, and supplemented with additional attributes that can define a more detailed classification. Similarly, the session profiling module 130 determines the level of commitment and delivers one or more parameters qualifying the user's commitment, ie the degree of interest or intention with regard to the content presented.

The system comprises a personalized content publisher server module 140, coupled to the session profiling module 130 and to a content provider module 150, that can also be operated by a third party. Said at least one center of interest and at least one measurement of the degree of commitment are provided by the personalized content publisher server module 140 by an API to the content provider module 150 which determines the content that is the most suited to the user as a function of elements provided to it and of an internal decision logic.

The content provider module 150 can be, in particular, a suitable advertisement sales or publishers' content recommendation system, for providing content supplied by a plurality of advertisers, or third-party publishers, from data sources 162, 164. In this way the personalized content is determined by the content provision module 150 outside the user's environment with no cookie retrieved from the navigation module 110 (for example cookie, tag, etc type) and with no direct interaction with this environment. Similarly, the identity information (or any other means of recognizing the user) is not used in determining the personalized content, since only the items of information from the anonymized session, supplied by the personalized content publisher server module 140, are used for decision making by the content provider module 150.

The system comprises a personalized content server module 170, coupled to the content provider module 150, which will perform the implementation of the personalized content in interaction with the navigation module 110.

The personalized content server 170 is also coupled to a module tracking the display of personalized information 190, as displayed on the navigation module 110, and interacting with the content server module 120 and/or the navigation module 110, making it possible to measure the display of the personalized content, thus ensuring the proper execution of a display contract, which can be a commercial type with third parties.

The system can comprise a content broadcasting network 180, coupled to the navigation module 110 and the advertiser server module of personalized content 170, to optimize their effectiveness in terms of response and display times.

FIG. 3 represents a detailed embodiment of the navigation module 110. The navigation module 110 comprises a user interface 310, typically a screen, and means for interactions with a user, such as a keyboard, a touch surface, sensors, etc. The user interface is in particular suitable for displaying content transmitted by a content server module 120.

The navigation module 110 comprises a module 320 for collecting elementary session data. The collection module 320 is configured to obtain, by means of the navigation module 110, information relating to

the user's interactions with the content presented, including, for example, web pages, supplied by the content server module 120. The information collected (logged) by the collection module 320 relates, for example, to the content of the pages viewed, keywords entered by the user, action and/or data entry by the user to perform a search, and/or browsing to access new information within the same site—using links, filters, all types of search, for example by image, etc.

The navigation module 110 comprises an iterative classification module 330, operating in real time, coupled to storage means 340 for the current session and to a session history database 350. The iterative classification module 330 is, in particular, configured to calculate the current session's context variables, ie at least one center of interest variable and at least one commitment variable, to store the information collected by the collection module 320 in the storage means, and to supply the necessary information to the content provider module 150.

The session history database 350 is coupled to a session profiling module 360 allowing the session history database 350 to be classified, by formulating at least one center of interest variable, and at least one commitment variable for each session stored.

The iterative classification module 330 is configured to transmit to the content provider module 150, at least one item of context information qualified by a center of interest of the user, determined as a function of:
the content of the pages viewed during a browsing session established by means of the navigation module 110; and/or,
a selection, by means of a semantic or machine learning method, of the most significant terms characterizing his content search request, whether keywords used or contents selected by the user to formulate his request, to the navigation module 110, intended for a search module of the content server module 120.

The session history database 350, coupled to a session profiling module 360, makes it possible to store a historical data set of previous sessions, said session data typically being obtained beforehand from a plurality of anonymous data collected during many users' sessions on the same website. The session profiling module 360 is also configured to enable a signature to be determined for each session of the historical data set of previous sessions, by formulating at least one center of interest variable and at least one commitment variable, and in this way make it possible to classify the sessions by degree of similarity (a method known as “Clustering”).

FIG. 2 shows the steps of a method predicting the behavior of the user, according to one embodiment of the invention. The prediction of the user's behavior is expressed as a function of the user's centers of interest and the user's commitment with regard to a content. The content is, for example, one or more web pages accessible locally, third party content inserted into the content page, advertising messages. For its part, the recommended content is typically generated by the content provider module 150, from one of the data sources 162, 164 of a third-party publisher or advertiser wishing to target the user's current context, and also more accurately his actual center of interest.

The method predicting the user's interest is designed to propose a personalized content to the user by analyzing:
the user's center of interest qualifying the context, as a function of:
   the classified and characterized content of the content viewed, for example pages viewed in a website, during a browsing session established by means of the navigation module 110; and/or
   a selection, by means of a semantic method or a method of learning and profiling by “Machine Learning”, of the most significant terms among the terms used by the user during his session to formulate, by means of the navigation module 110, a content search request, intended for a search module of the content server module 120;
the user's behavioral commitment, as a function of interactions within the pages transmitted by the content server module 120 to the navigation module 110.

The behavioral commitment with a content, and in particular the advertising commitment or the commitment with regard to the advertisement, denotes the fact of being receptive to and interacting with a content or an advertising item. The fact of reading an article through to its lowest portion requiring it to be scrolled, or the fact of watching a video to its end, are examples of the user's commitment with regard to the content. In the field of internet advertising, the advertising commitment is frequently the fact that an internet user interacts with an advertising item apart from and other than by clicking. The notion of commitment is mainly used for so-called “rich media” formats and constitutes an indicator of effectiveness in addition to the click rate and post-view indicators. The commitment can be expressed, for example, by the fact of:
causing an extensible banner to be expanded;
activating the playing or replaying of an advertising video;
playing within a banner;
replaying a so-called “rich media”;
marking a content or advertisement with a “Like”.

The fact of considering an interaction to be a commitment is sometimes abusive, since mousing-over can sometimes be completely unintentional. Because of this, the measurement of the commitment is better when it is based on several commitment actions or can be derived from iterative actions. The commitment can be measured by one or more different types of levels of commitment, linked for example to interactions relating to the text, images and/or videos.

The method predicting the behavior of the user comprises a step 210 of collecting, during a current session, information relating to new interactions by the user, by means of the navigation module 110, with pages supplied by the content server module 120.

Advantageously, the step 210 is executed periodically or after detecting a new interaction by the user within a content or a web page supplied by the content server module 120 to the navigation module 110. The information relating to the new interactions is collected for a single website, and relates, for example, to the content of the pages viewed, keywords entered by the user, action and/or data entry by the user to perform a search, and/or to access new information within the same site—links, filters, image-based search, etc. The collecting of information therefore solely concerns the data accessible during the user's current session: no information relating to an internet navigation history of the user is collected. In addition, the cookies are not used to identify the user.

The method predicting the behavior of the user comprises a step 220 of accessing, during a current session, information relating to interactions by the user, by means of the navigation module 110, with pages supplied by the content server module 120. Typically, this concerns information relating to the content viewed and to interactions that the user generated, previously, during the current session, updated through to his last interaction. The information relating to interactions is obtained for a single website, and relates, for example, to the content of the pages viewed, keywords entered by the user, action and/or data entry by the user to perform a search, and/or to access new information within the same site—links, filters, image-based search, etc. The collecting of information therefore only concerns the data accessible during the user's current session: no information relating to an internet navigation history of the user is collected. In addition, the cookies are not used to identify the user.

The method predicting the behavior of the user comprises a step 230 of fusing information relating to the user's new interactions obtained during the step 210, with the information relating to the user's interactions obtained during the step 220, ie with the history of his current session.

The method predicting the behavior of the user comprises a step 240 of determining and refining the context, making it possible to define and then improve the accuracy of the user's center of interest, from data fused during step 230. At the end of step 240, at least one context and/or one center of interest of the user is/are determined and/or refined, by combining:
the content of the pages viewed during the current browsing session established by means of the navigation module 110; and/or
a selection, by means of a semantic method, of the most significant terms associated with, or equivalent to, the user's content search requests, regardless of the nature of his request, that can combine words, actions on the content, images, videos, by means of the navigation module 110, intended for a search module of the content server module 120.

Therefore, as well as the information relating to the content of the pages consulted of the user (and the non-visible metadata that can be associated with them), the keywords entered by the user, images and/or images, that was used by the user to formulate one or more successive search requests, the user's center(s) of interest is/are determined, during the step 240, as a function of one or more reference ontologies or thesauruses relating to a plurality of concepts illustrating various different centers of interest.

Similarly, the method predicting the behavior of the user comprises a step 250 of determining and refining the user's commitment, as a function of the behavioral data fused during step 230. More specifically, at the end of step 250, at least one measurement of the user's commitment is defined and/or refined, as a function of the behavioral interactions within the pages transmitted by the content server module 120 to the navigation module 110, obtained from data fused during step 230.

The behavior of a user exploring a content in a website, or supplied through an application, is characterized by all the user's interactions with the man-machine interface. The behavior is formulated from all the events reflecting all the human actions positioned on a time axis. As a non-limiting example, it can consist of the following events:
all types of clicking on a page, a button, a content, etc;
scrolling through a page, starting a video and the time spent watching, etc, writing words in a search bar, dragging and dropping content, etc;
all actions on the keyboard, a touch screen, and more generally any interactions with the user interface.

Behavioral variables will be deduced from these, such as, but not limited to:
the time between two actions by the user;
number of pages viewed, time spent viewing a page;
number of images viewed, and average time per image;
number of videos viewed, viewing time and percentage for videos;
number of actions according to the type of content: text, image, video.

The method predicting the commitment of the user comprises a step 260 of characterizing the “center of interest” and “commitment” of the user, as a function of center of interest variables for the user determined during step 240 and commitment variables for the user determined during step 250.

At the end of step 260, a degree of intent is obtained for the user. The characterization of the user's current session is obtained by:
determining a signature for the current session, as a function of the context and/or the center of interest of the user determined during step 240 and the measurement of the user's commitment, determined during step 250;
obtaining a historical data set of previous sessions, said session data typically being obtained beforehand from a plurality of anonymous data collected during many users' sessions on a plurality of websites;
determining, from amongst the historical data set of anonymized previous user sessions, the historicized previous sessions having signatures closest to the current session's signature;
determining, from classification model, the characteristics of the user's current session, as a function of characteristics associated with a cluster of previous sessions having signatures closest to the current session's signature.

In this way, it is possible to analyze the user's current activity and to compare it to the activity of previous users who had accessed the same types of information on the same website, based on previously recorded and anonymized sessions. Techniques known as “Machine Learning” can, in particular, be used to classify the user's center of interest and commitment with regard to a multitude of groups of sessions, so as to propose to advertisers and publishers the purchase of sponsored content or advertising inserts in which they will propose personalized content closest to the user's center of interest and knowing in advance his current degree of commitment with regard to the content presented.

The method predicting the commitment of the user comprises a step 270 of selecting a personalized content from a content set, as a function of the center of interest and degree of commitment determined during step 260, then transmitted to the navigation module 110 to be displayed.

1. Method for broadcasting personalized content, in a communication network, to a navigation module, during a session established between the navigation module and a content server module, referred to as the current session, the method comprising the following steps:
a first step of collecting information relating to at least one interaction of a user, by means of a navigation module, with at least one content page prepared at least partially from data transmitted by the content server module;
a second step of determining a context variable relating to at least one center of interest of the user, as a function of information relating to said at least one interaction of a user collected during the first step;
a third step of determining at least one commitment variable of the user with said at least one content page, as a function of information relating to said at least one interaction of a user collected during the first step;
a fourth step of characterizing the current session as a function of a historical data set of anonymized previous sessions:
of the context as a function of said at least one context variable relating to at least one center of interest of the user; and
of said at least one measurement of the user's commitment or at least one measurement of the user's degree of interest, as a function of said at least one commitment variable determined during the third step;
a fifth step of broadcasting, to the navigation module, a content personalized as a function of the characterization of the context and of the characterization of said at least one measurement of the degree of commitment or said at least one measurement of the degree of interest, determined during the fourth step.

2. Method according to claim 1 wherein, during the fifth step, the content personalized for the user is determined and/or selected by a content provider module, as a function of the characterization of the context and of the characterization of said at least one measurement of the degree of commitment or said at least one measurement of the degree of interest, determined during the fourth step.

3. Method according to claim 1, wherein the first step is executed periodically or after detecting a new interaction by the user within a content page transmitted by the content server module.

4. Method according to claim 1, wherein said at least one interaction of the user with said at least one content page transmitted by the content server module is relative to one or a combination of interactions from among the following list: consulting a content page/web page, consulting a sub-section of a web page via a link or a menu, entering a keyword, expressing an interest or non-interest in a multimedia document, action and/or data entry by the user to perform a content search, browsing action and/or data entry by the user to access new information within the content server or website.

5. Method according to claim 1, wherein, during the second step, said at least one context variable is determined, as a function of the content of said at least one content page and/or information, not visible to the user, attached to said content.

6. Method according to claim 1, wherein, during the second step, said at least one context variable is determined as a function of a selection and/or a combination, on input, of criteria, and/or actions, and/or objects used by the user to formulate, by means of the navigation module, a personalized content request, intended for a search module associated to the content server module.

7. Method according to claim 6 wherein, during the second step, said at least one context variable is determined, as a function of a selection and/or a combination, on input, of at least one item of textual information and/or at least one multimedia object, to formulate the personalized content request, intended for the search module associated to the content server module.

8. Method according to claim 1, wherein, during the second step, said at least one context variable is determined, as a function of the content of said at least one content page transmitted to the navigation module, and as a function of at least one reference ontology relating to a plurality of concepts.

9. Method according to claim 1, wherein the historical data set of previous sessions comprises anonymous data collected during user sessions established between third-party navigation modules and the content server module.

10. Method according to claim 1, wherein, during the fourth step, the characterization of the context is determined by:
formulating a signature of the session, as a function of said at least one context variable;
comparing the signature of the current session with the historical data set of anonymized previous user sessions, to determine historicized previous sessions having a signature closest to the session's signature;
using a classification model, to determine the characteristics of the user's current session, as a function of characteristics associated with the historicized previous sessions having a signature closest, in terms of classification, to the signature of the current session.

11. Method according to claim 2 wherein, during the fifth step, the personalized content is:
selected from a content set, as a function of the characterization of the context and of the characterization of said at least one measurement of the degree of commitment or said at least one measurement of the degree of interest;
transmitted to the navigation module,
displayed by the navigation module.

12. Computer program comprising instructions for executing steps of one of the methods according to claim 1 wherein said program is executed by a processor.

13. Computer-readable recording medium on which is stored a computer program comprising instructions for executing steps of one of the methods according to claim 1.

14. Module designed to broadcast a personalized content, in a communication network, to a navigation module, during a session established between the navigation module and a content server module, that comprises:
a module configured to collect information relating to at least one interaction of a user, by means of a navigation module, with at least one content page prepared at least partially from data transmitted by the content server module;
a module configured to determine a context variable relating to at least one center of interest of the user, as a function of information relating to said at least one interaction of a user;
a module configured to determine at least one commitment variable of the user with said at least one content page, as a function of information relating to said at least one interaction of a user;
a module configured to determine, as a function of a historical data set of anonymized previous sessions:
a characterization of the context as a function of said at least one context variable relating to at least one center of interest of the user; and
a characterization of said at least one measurement of the user's commitment or at least one measurement of the user's degree of interest, as a function of said at least one commitment variable;
a module configured to broadcast, to the navigation module, a content personalized as a function of the characterization of the context and of the characterization of said at least one measurement of the degree of commitment or said at least one measurement of the degree of interest.

15. System comprising a navigation module, a content server module and a module according to claim 14.
